(19) United States
(12) Patent Application Publication
(10) Pub. No.: US 2008/0200163 A1
(43) Pub. Date: Aug. 21, 2008

(54) MOBILE COMMUNICATION APPARATUS, METHOD AND COMPUTER READABLE MEDIUM THEREOF CAPABLE OF DETERMINING WHETHER TO KEEP SEARCHING FOR AVAILABLE BASE STATIONS

(75) Inventors: Kun-Chan Tsai, Hue-Kuei Village (TW); Hung-Wei Wu, Taichung (TW); Yao-Chuan Wu, Kaohsiung (TW); Chien-Wen Wang, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/675,592

(22) Filed: Feb. 15, 2007

(51) Int. Cl. H04Q 7/20

(52) U.S. Cl. 455/423

(57) ABSTRACT

A positioning module positions the location of the mobile communication apparatus. A determination module stores a map and determines whether the location of the mobile communication apparatus is within one of the effective communication ranges of the available base stations based on the map. A processing module ceases searching for the signals of available base stations if the location of the mobile communication apparatus is determined not to be within one of the effective communication ranges. A mobile communication apparatus can cease searching for the signals of available base stations if the mobile communication apparatus is not within one of the effective communication ranges of any available base stations or the search takes too much time. Therefore, power is saved.

### CROSS-REFERENCES TO RELATED APPLICATIONS

Not applicable.

### BACKGROUND OF THE INVENTION

1. Field of the Invention

The present invention relates to a mobile communication apparatus, a method, and a computer readable medium thereof, more specifically, relates to a mobile communication apparatus, a method, and a computer readable medium thereof capable of determining whether to keep searching for available base stations according to the location of the mobile communication apparatus.

2. Descriptions of the Related Art

The wide use of mobile phones has prompted many advanced technological developments, as well as many different types of mobile phones. One type is the global system mobile communications (GSM), which provide wireless voice and data transmissions via base stations. This type of mobile phone searches neighboring and available base stations after startup. When the mobile phone detects a signal from one base station, it checks and decides whether the signal is good enough to camp on the base station. If it decides to camp on the base station, it performs registration and location update via the base station. After that, the mobile phone can access various services of the wireless communication network through the base station.

However, when the mobile phone consistently can not detect a signal from a base station, the mobile phone will continuously search for a signal from any base station. Unfortunately, if the mobile phone is not within an effective communication range of any base station, the mobile phone is consequently wasting unnecessary electric power.

Accordingly, a solution that prevents the mobile phone from continuously searching for signals from base stations and thereby, wasting unnecessary electric power, is needed in this field.

### SUMMARY OF THE INVENTION

One objective of this invention is to provide a mobile communication apparatus. The mobile communication apparatus comprises a positioning module, a determining module, and a processing module. The positioning module positions a location of the mobile communication apparatus. The determination module determines whether the location of the mobile communication apparatus is within one of effective communication ranges of available base stations. If the location of the mobile communication apparatus is not within one effective communication range, then the processing module ceases searching for any base station signal.

Another objective of this invention is to provide a mobile communication method. The method comprises the following steps: positioning a location; determining whether the location of the mobile communication apparatus is within one of effective communication ranges of available base stations; and ceasing searching for any base station signal if the location of the mobile communication apparatus is determined to not be within one of the effective communication ranges.

Another objective of this invention is to provide a computer readable medium that stores a computer program for executing a mobile communication method of a mobile communication apparatus. The method comprises the following steps: positioning a location of the mobile communication apparatus; determining whether the location of the mobile communication apparatus is within one of effective communication ranges of available base stations; and ceasing searching for any base station signal if the location of the mobile communication apparatus is determined to not be within one of the effective communication ranges.

The present invention can determine the position of a mobile communication apparatus and can determine whether the mobile communication apparatus is within one effective communication range of available base stations. If the mobile communication apparatus is determined not to be within one of effective communication ranges of any available base stations, the mobile communication apparatus ceases searching for any base station signal. Accordingly, the mobile communication apparatus of the present invention can avoid the unnecessary detection of base station signals. In areas with a sparse population in which base stations are few, the present invention can certainly save power, thereby increasing the operation time of the mobile communication apparatus.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating a communication system;

FIG. 2 is a schematic diagram illustrating a first embodiment of the present invention;

FIG. 3 is a flow chart illustrating a second embodiment of the present invention; and

FIG. 4 is a flow chart illustrating a third embodiment of the present invention.

### DESCRIPTION OF THE PREFERRED EMBODIMENT

In this specification, the term “in response to” is defined as “replying to” or “reacting to.” For example, “in response to a signal” means “replying to a signal” or “reacting to a signal” without necessity of a direct signal reception.

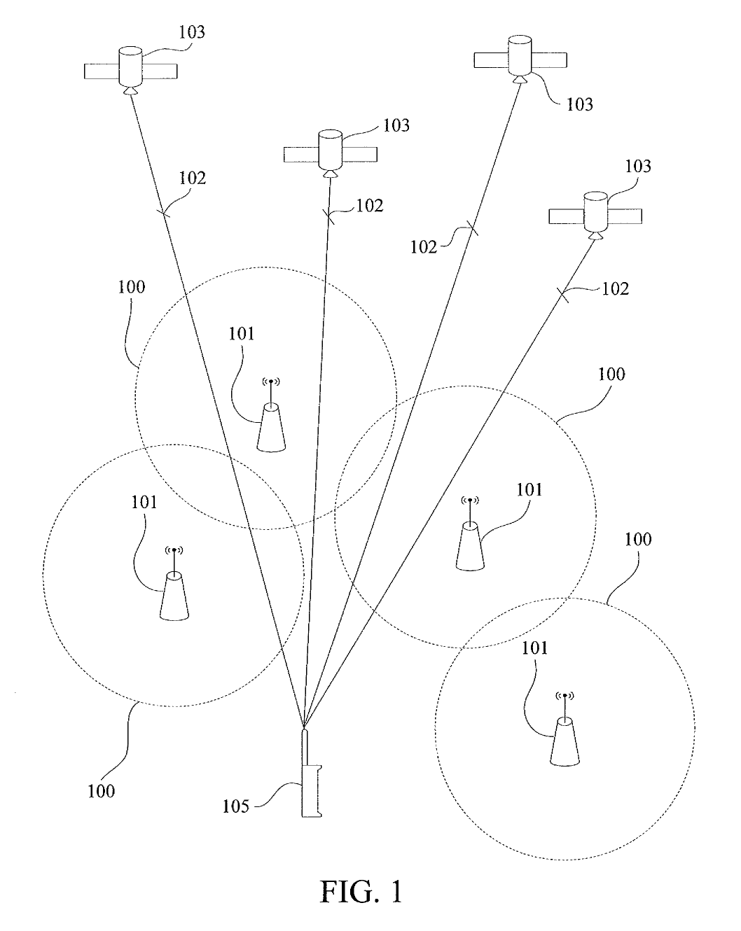

FIG. 1 illustrates a schematic diagram of a first embodiment in accordance with the present invention, which is a communication system. The communication system comprises a plurality of available base stations 101, a plurality of satellites 103, and a mobile communication apparatus 105. Each available base station 101 has an effective communication range 100. The satellites 103 provide positioning signals 102 which are based on either the global positioning system (GPS), global navigation satellite system (GLONASS), Galileo positioning system (GPS), or other satellite-based positioning systems. The mobile communication apparatus 105 can be a mobile phone that uses GSM or a phone that uses other wireless communication systems.

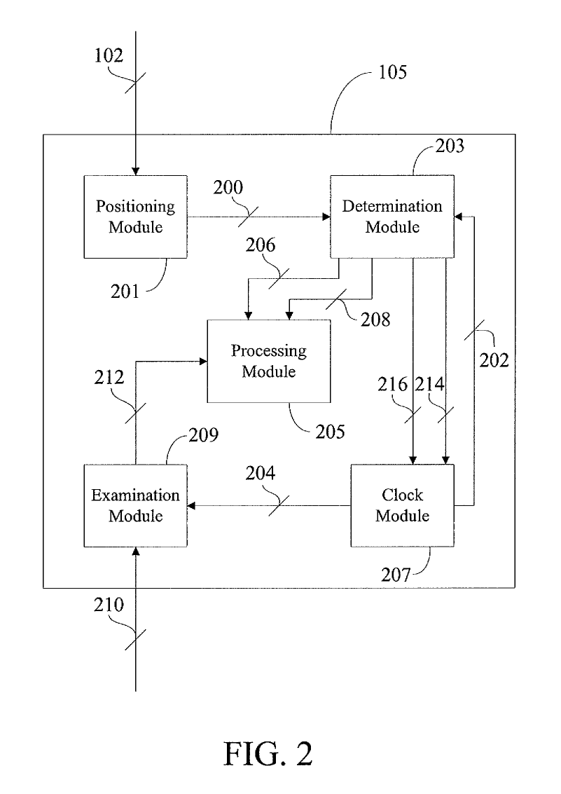

As shown in FIG. 2, the mobile communication apparatus 105 comprises a positioning module 201, a determination module 203, a processing module 205, a clock module 207, and an examination module 209. The positioning module 201 receives the positioning signals 102 from the satellites 103 to position a location of the mobile communication apparatus 105. In response to the positioning, a location signal 200 is generated. When the mobile communication apparatus 105 starts to search for any available base station after powered on or disconnection, the clock module 207 clocks a first predetermined time. The determination module 203 stores a map which includes the information for locations of the available base stations 101 and the effective communication ranges 100 thereof. The processing module 205 is configured to control the search of the signals coming from available base stations 101.

As long as the determination module 203 determines that the search time is not greater than the first predetermined time 202, the determination module 203 transmits a searching signal 208. And in response to the searching signal 208, the processing module 205 keeps searching for the signals of available base stations 101 until the mobile communication apparatus 105 camps on one available base station 101. If the search time reaches the first predetermined time 202, the determination module 203 further determines whether the location of the mobile communication apparatus 105 is within one of the effective communication ranges 100 of the available base stations 101 in response to the map and the location signal 200.

If the location of the mobile communication apparatus 105 is determined within one of the effective communication ranges 100, the determination module 203 transmits a re-clock signal 214 to the clock module 207, and the clock module 207 re-clocks the first predetermined time 202 for the determination module 203 to re-search the signals of available base stations 101. If the location of the mobile communication apparatus 105 is determined not to be within one of the effective communication ranges 100, the determination module 203 transmits a clock signal 216 to the clock module 207, and the clock module 207 clocks a second predetermined time 204.

During the second predetermined time 204, the examination module 209 determines whether a user inputs an instruction 210. If no instruction is inputted during the second predetermined time 204 or the instruction 210 is inputted and indicates that the user would like to cease the search of base station signals, the examination module 209 sends a control signal 212 to the processing module 205 to cease the search of base station signals. If the instruction 210 is inputted but indicates that the user would like to keep the search of base station signals, the clock module 207 re-clocks the first predetermined time 202 for the determination module 203 to re-search the signals of available base stations 101.

The determination module 203 of some other embodiments may transmit a ceasing signal 206 to the processing module 205 if the location of the mobile communication apparatus 105 is determined not to be within one of the effective communication ranges 100 automatically. When the mobile communication apparatus 105 starts to search for any available base station after powered on or disconnection, the clock module 207 clocks the first predetermined time. As long as the determination module 203 determines that the search time is not greater than the first predetermined time 202, the determination module 203 transmits the searching signal 208 to the processing module 205 to keep searching for the signals of available base stations 101 until the mobile communication apparatus 105 camps on one available base station 101. If the search time reaches the first predetermined time 202, the determination module 203 further determines whether the location of the mobile communication apparatus 105 is within one of the effective communication ranges 100 of the available base stations 101 in response to the map and the location signal 200.

If the location of the mobile communication apparatus 105 is determined within one of the effective communication ranges 100, the determination module 203 transmits a re-clock signal 214 to the clock module 207, and the clock module 207 re-clocks the first predetermined time 202 for the determination module 203 to re-search the signals of available base stations 101. If the location of the mobile communication apparatus 105 is determined not to be within one of the effective communication ranges 100, the determination module 203 transmits the ceasing signal 206 to the processing module 205. As a result, the processing module 205 ceases the search in response to the ceasing signal 206 because the determination module 203 determines that the opportunity to find an available base station 101 is little.

After the search of base station signals is ceased, the positioning module 201 still receives the positioning signals 102 from the satellites 103, and positions the location of the mobile communication apparatus 105 to generate the location signal 200. And the determination module 203 determines whether the location of the mobile communication apparatus 105 is within one of the effective communication ranges 100 of the available base stations 101 in response to the map and the location signal 200 continuously until the location of the mobile communication apparatus 105 is within one of the effective communication ranges 100 of the available base stations 101.

Although FIG. 2 illustrates that the determination module 203 transmits the ceasing signal 206 and the searching signal 208 via two physical signal lines, message delivery, or functions call, the invention is not limited to those. More specifically, the determination module 203 can use, for example, a high level and a low level, carried by a physical single line, message delivery, or functions call to instruct keeping or ceasing the search of base station signal, respectively. In such a case, the high level may correspond to the ceasing signal 206, while the low level may correspond to the searching signal 208.

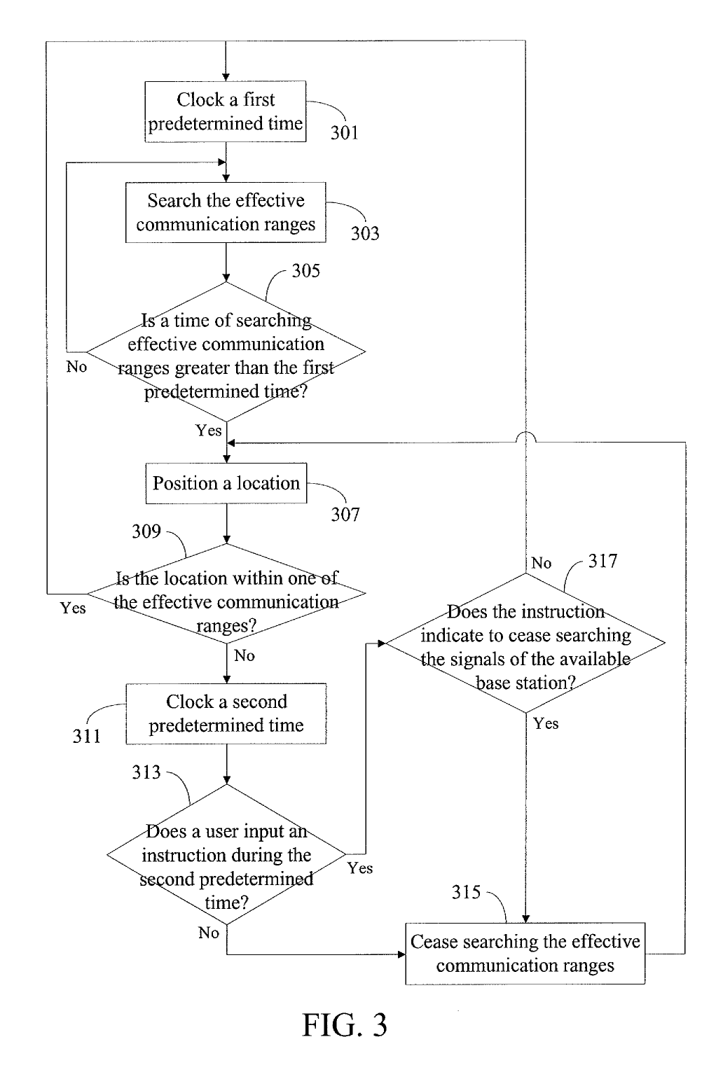

FIG. 3 illustrates a second embodiment of the present invention, which is a mobile communication method executed manually in a mobile communication apparatus, such as the mobile communication apparatus 105. The mobile communication apparatus is controlled by a software program to perform the method. When the mobile communication apparatus starts to search for any available base station after powered on or disconnection, step 301 is executed in which the software program comprises the code for controlling the clock module to clock a first predetermined time. Then, step 303 is executed in which the software program comprises the code for controlling the processing module to search for the signals of available base stations. Then, step 305 is executed in which the software program comprises the code for controlling the determination module to determine whether a search time of searching the signals of the available base stations is greater than the first predetermined time.

In step 305, if the first predetermined time is not greater than the search time, the mobile communication method returns to step 303 to keep searching for the signals of available base stations. In step 305, if the search time reaches the first predetermined time, step 307 is executed in which the software program comprises the code for controlling the positioning module to position a location of the mobile communication apparatus. Then, step 309 is executed in which the software program comprises the code for controlling the determination module to determine whether the location of the mobile communication apparatus is within one of the effective communication ranges of the available base stations.

In step 309, if the location of the mobile communication apparatus is determined to be within one of the effective communication ranges, the mobile communication method returns to step 301. In step 309, if the location of the mobile communication apparatus is determined not to be within one of the effective communication ranges, step 311 is executed in which the application program comprises the code for controlling the clock module to clock a second predetermined time. Then step 313 is executed in which the software program comprises the code for controlling the examination module to determine whether a user inputs an instruction during the second predetermined time.

In step 313, if no instruction is inputted during the second predetermined time, step 315 is executed in which the software program comprises the code for controlling the processing module to cease searching signals of the available base stations. If the instruction is inputted during the second predetermined time, then step 317 is executed in which the software program comprises the code for controlling the examination module to determine whether the instruction indicates to cease searching the signals of the available base stations.

In step 317, if the instruction indicates to cease searching the signals of the available base stations, step 315 is executed in which the software program comprises the code for controlling the processing module to cease the search of base station signals. If the instruction indicates not to cease searching the signals of the available base stations, then the mobile communication method returns to step 301.

After the search of base station signals is ceased, the method goes back to execute step 307 and step 309 to determine whether the location of the mobile communication apparatus is within one of the effective communication ranges of the available base stations continuously until the location of the mobile communication apparatus is within one of the effective communication ranges of the available base stations.

In addition to the steps shown in FIG. 3, the software program for the mobile communication method has other code that allow for the apparatus to execute all of the operations or functions recited in the first embodiment. Those skilled in the art can straightforwardly realize how the mobile communication method performs these operations and functions based on the above descriptions of the first embodiment. Therefore, the descriptions for these operations and functions are redundant and not repeated herein.

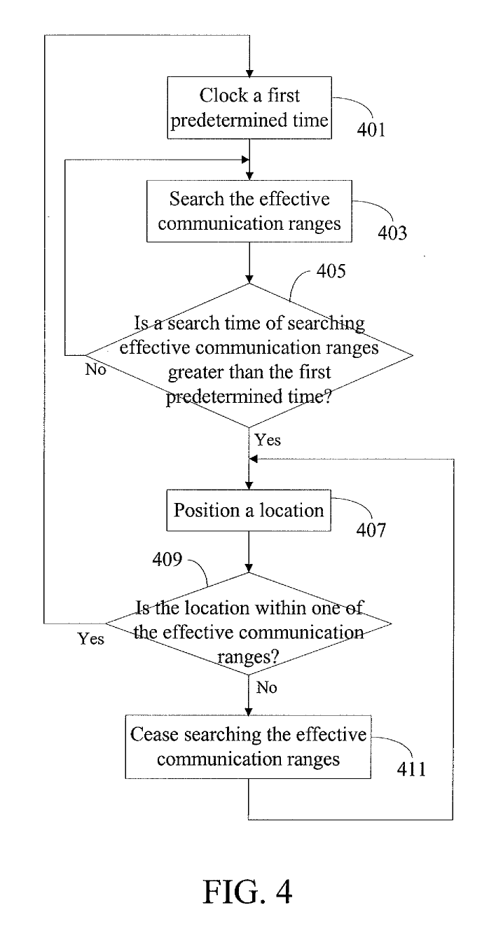

FIG. 4 illustrates a third embodiment of the present invention, which is also a mobile communication method executed automatically in a mobile communication apparatus, such as the mobile communication apparatus 105. The mobile communication apparatus is controlled by a software program to perform the method. When the mobile communication apparatus starts to search for any available base station after powered on or disconnection, step 401 is executed in which the software program comprises the code for controlling the clock module to clock a first predetermined time. Then, step 403 is executed in which the software program comprises the code for controlling the processing module to search for the signals of available base stations. Then, step 405 is executed in which the software program comprises the code for controlling the determination module to determine whether a search time of searching the signals of the available base stations is greater than the first predetermined time.

In step 405, if the first predetermined time is greater than the search time, the mobile communication method returns to step 403 to keep searching for the signals of available base stations. If the search time reaches the first predetermined time, step 407 is executed in which the software program comprises the code for controlling the positioning module to position a location of the mobile communication apparatus. Then, step 409 is executed in which the software program comprises the code for controlling the determination module to determine whether the location of the mobile communication apparatus is within one of the effective communication ranges of the available base stations.

In step 409, if the location of the mobile communication apparatus is determined to be within one of the effective communication ranges of the available base stations, the mobile communication method returns to step 401. If the location of the mobile communication apparatus is determined not to be within one of the effective communication ranges, step 411 is executed in which the software program comprises the code for controlling the determination module to transmit a ceasing signal to the processing module to cease the search of base station signals. After the search of base station signals is ceased, the method goes back to execute step 407 and step 409 to determine whether the location of the mobile communication apparatus is within one of the effective communication ranges of the available base stations continuously until the location of the mobile communication apparatus is within one of the effective communication ranges of the available base stations.

In addition to the steps shown in FIG. 4, the software program for the mobile communication method has other code that allow for the apparatus to execute all of the operations or functions recited in the first embodiment. Those skilled in the art can straightforwardly realize how the mobile communication method performs these operations and functions based on the above descriptions of the first embodiment. Therefore, the descriptions for these operations and functions are redundant and not repeated herein.

The software program may be stored in a computer readable medium. The software readable medium can be a floppy disk, a hard disk, an optical disc, a flash disk, a tape, a network accessible database or a storage medium with the same functionality which can be easily thought by people skilled in the field, the invention is not limited to those.

Accordingly, the present invention is able to make a mobile communication apparatus cease searching for the signals of available base stations if the mobile communication apparatus is not within one of the effective communication ranges of any available base stations or the search takes too much time. Therefore, the present invention can fully avoid the unnecessary searching of the signals of available base stations, thereby saving electric power and increasing the operation time.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mobile communication apparatus, comprising:
a positioning module for positioning a location of the mobile communication apparatus;
a determination module for determining whether the location of the mobile communication apparatus is within one of effective communication ranges of available base stations; and
a processing module for ceasing searching signals of the available base stations if the location of the mobile communication apparatus is determined not within one of the effective communication ranges.

2. The mobile communication apparatus as claimed in claim 1, wherein the processing module searches the signals of the available base stations if the location is determined within one of the effective communication ranges.

3. The mobile communication apparatus as claimed in claim 1, wherein after the processing module ceases searching the signals of the available base stations, the positioning module positions the location of the mobile communication apparatus, and the determination module determines whether the location of the mobile communication apparatus is within one of the effective communication ranges of the available base stations continuously.

4. The mobile communication apparatus as claimed in claim 1, further comprising a clock module for clocking a first predetermined time, wherein the determination module determines whether a time of searching the signals of available base stations is greater than the first predetermined time, and the determination module starts to perform the location determination operation if the time of searching the signals of the available base stations reaches the first predetermined time.

5. The mobile communication apparatus as claimed in claim 4, wherein the processing module keeps searching the signals of the available base stations if the first predetermined time is determined greater than the time of searching the signals of the available base stations.

6. The mobile communication apparatus as claimed in claim 1, further comprising:
a clock module for clocking a second predetermined time if the location of the mobile communication apparatus is determined not within one of the effective communication ranges; and
an examination module for determining whether a user inputs an instruction during the second predetermined time;
wherein the processing module performs the ceasing operation if no instruction is inputted during the second predetermined time

7. The mobile communication apparatus as claimed in claim 6, wherein the examination module further determines whether the instruction indicates to cease searching the signals of the available base stations if the instruction is inputted during the second predetermined time, and the processing module performs the ceasing operation if the instruction indicates to cease searching the signals of the available base stations.

8. The mobile communication apparatus as claimed in claim 7, wherein the processing module keeps searching the signals of the available base stations if the instruction indicates not to cease searching the signals of the available base stations.

9. The mobile communication apparatus as claimed in claim 1, wherein the determination module stores a map comprising information for locations of the available base stations and the effective communication ranges of base stations, and the determination module performs the location determination operation based on the map.

10. The mobile communication apparatus as claimed in claim 1, wherein the positioning module positions the location based on one of Global Positioning System (GPS), Global Navigation Satellite System (GLONASS), and Galileo Positioning System (GPS).

11. A mobile communication method, comprising the steps of:
positioning a location of a mobile communication apparatus;
determining whether the location of the mobile communication apparatus is within one of effective communication ranges of available base stations; and
ceasing searching signals of the available base stations if the location of the mobile communication apparatus is determined not within one of the effective communication ranges.

12. The mobile communication method as claimed in claim 11, further comprising the step of searching the signals of the available base stations if the location is determined within one of the effective communication ranges.

13. The mobile communication method as claimed in claim 11, wherein after the ceasing step is executed, the positioning step and the determining step are executed continuously.

14. The mobile communication method as claimed in claim 11, further comprising the steps of:
clocking a first predetermined time; and
determining whether a time of searching the signals of the available base stations is greater than the first predetermined time;
wherein the step of determining whether the location of the mobile communication apparatus is within one of effective communication ranges of available base stations is executed if the time of searching the signals of the available base stations reaches the first predetermined time.

15. The mobile communication method as claimed in claim 14, further comprising the step of keeping searching the signals of the available base stations if the first predetermined time is determined greater than the time of searching the signals of the available base stations.

16. The mobile communication method as claimed in claim 11, further comprising the steps of:
clocking a second predetermined time if the location of the mobile communication apparatus is determined not within one of the effective communication ranges; and
determining whether a user inputs an instruction during the second predetermined time;
wherein the ceasing step is executed if no the instruction is inputted during the second predetermined time.

17. The mobile communication method as claimed in claim 16, further comprising the steps of:
determining whether the instruction indicates to cease searching the signals of the available base stations if the instruction is inputted during the second predetermined time;
wherein the ceasing step is executed if the instruction indicates to cease searching the signals of the available base stations.

18. The mobile communication method as claimed in claim 17, further comprising the step of keeping searching the signals of the available base stations if the instruction indicates not to cease searching the signals of the available base stations.

19. The mobile communication method as claimed in claim 11, further comprising the step of storing a map comprising information for locations of the available base stations and the effective communication ranges of base stations, wherein the determining step is executed based on the map.

20. A computer readable medium storing a computer program having code for a mobile communication apparatus to execute a mobile communication method, the mobile communication method comprising the steps of:
positioning a location of the mobile communication apparatus;
determining whether the location of the mobile communication apparatus is within one of effective communication ranges of available base stations; and
ceasing searching signals of the available base stations if the location of the mobile communication apparatus is determined not within one of the effective communication ranges.

21. The computer readable medium as claimed in claim 20, wherein the method further comprises the step of searching the signals of the available base stations if the location is determined within one of the effective communication ranges.

22. The computer readable medium as claimed in claim 20, wherein after the ceasing step is executed, the positioning step and the determining step are executed continuously.

23. The computer readable medium as claimed in claim 20, wherein the method further comprises the steps of:
clocking a first predetermined time; and
determining whether a time of searching the signals of the available base stations is greater than the first predetermined time;
wherein the step of determining whether the location of the mobile communication apparatus is within one of effective communication ranges of available base stations is executed if the time of searching the signals of the available base stations reaches the first predetermined time.

24. The computer readable medium as claimed in claim 23, wherein the method further comprises the step of keeping searching the signals of the available base stations if the first predetermined time is determined greater than the time of searching the signals of the available base stations.

25. The computer readable medium as claimed in claim 20, wherein the method further comprises the steps of:
clocking a second predetermined time if the location of the mobile communication apparatus is determined not within one of the effective communication ranges; and
determining whether a user inputs an instruction during the second predetermined time;
wherein the ceasing step is executed if no instruction is inputted during the second predetermined time.

26. The computer readable medium as claimed in claim 25, wherein the method further comprises the steps of:
determining whether the instruction indicates to cease searching the signals of the available base stations if the instruction is inputted during the second predetermined time;
wherein the ceasing step is executed if the instruction indicates to cease searching the signals of the available base stations.

27. The computer readable medium as claimed in claim 26, wherein the method further comprises the step of keeping searching the signals of the available base stations if the instruction indicates not to cease searching the signals of the available base stations.

28. The computer readable medium as claimed in claim 20, wherein the method further comprises the step of storing a map comprising information for locations of the available base stations and the effective communication ranges of base stations, and the determining step is executed based on the map.
